(19) United States
(12) Patent Application Publication
(10) Pub. No.: US 2026/0116293 A1
(43) Pub. Date: Apr. 30, 2026

(54) HEADLIGHT CONTROL DEVICE AND LAMP DRIVER

(71) Applicant: TOYOTA JIDOSHA KABUSHIKI KAISHA, Toyota-shi (JP)

(72) Inventor: Oki SHIMIZU, Toyota-shi (JP)

(73) Assignee: TOYOTA JIDOSHA KABUSHIKI KAISHA, Toyota-shi (JP)

(21) Appl. No.: 19/338,243

(22) Filed: Sep. 24, 2025

(30) Foreign Application Priority Data
Oct. 31, 2024 (JP) 2024-191863

(51) Int. Cl. B60Q 11/00; B60Q 1/04

(52) U.S. Cl. CPC B60Q 11/002; B60Q 1/04

(57) ABSTRACT

A headlight control device comprising a first processor configured to provide an instruction to turn on and turn off the headlight, and a second processor configured to turn on or turn off the headlight based on the instruction. The first processor is configured to detect a vehicle state and output a lamp instruction signal and a vehicle state signal. The second processor is configured to diagnose the communication state with the first processor, configured to acquire the lamp instruction signal and the vehicle state signal, configured to execute control to turn on or off the headlight in accordance with the acquired lamp instruction signal, and configured to determine whether communication with the first processor is interrupted due to an abnormality based on the diagnosed communication state and acquired vehicle state signal.

### CROSS-REFERENCE TO RELATED APPLICATION

This application claims priority to Japanese Patent Application No. 2024-191863 filed on October 31, 2024. The disclosure of the above-identified application, including the specification, drawings, and claims, is incorporated by reference herein in its entirety.

### BACKGROUND

### 1. Technical Field

The present disclosure relates to a headlight control device and a lamp driver.

### 2. Description of Related Art

As a headlight control device of the related art, for example, a technique including two ECUs that are installed near headlights separately mounted on right and left sides of a front portion of a vehicle and control the respective headlights as described in Japanese Unexamined Patent Application Publication No. 2010-184540 (JP 2010-184540 A) is known.

### SUMMARY

Headlight lighting control is implemented by, for example, outputting a lighting instruction signal to a lamp driver through CAN communication. When the CAN communication is interrupted due to an abnormality while the vehicle is traveling, the headlights are required to be forcibly turned on. On the other hand, while the vehicle is stopped, the CAN communication may be stopped for the purpose of reducing standby electric power. Thus, it is necessary to determine whether the CAN communication is interrupted due to an abnormality. However, while the vehicle is stopped, it is not possible to determine whether the interruption is an interruption of the CAN communication due to an abnormality or an interruption of the CAN communication caused by intentionally stopping the CAN communication. Thus, a dedicated line for informing the lamp driver of the stopped state of the vehicle may be used separately from a CAN communication line. However, in this case, the addition of the dedicated line increases cost and makes wiring complicated.

The present disclosure provides a headlight control device and a lamp driver that enable cost reduction and simplification of wiring.

(1) An aspect of the present disclosure is a headlight control device that is configured to control a headlight of a vehicle. The headlight control device comprises a first processor and a second processor. The first processor is configured to provide an instruction to turn on and turn off the headlight. The first processor is configured to detect whether the vehicle is in a traveling state or a stopped state as a vehicle state. The first processor is configured to output, to the second processor, a lamp instruction signal to turn on or turn off the headlight, and a traveling state signal or a stopped state signal as a vehicle state signal corresponding to the vehicle state. The second processor is configured to turn on or turn off the headlight in accordance with the instruction of the first processor. The second processor is configured to diagnose a communication state with the first processor. The second processor is configured to acquire the lamp instruction signal and the vehicle state signal that are output from the first processor. The second processor is configured to execute control to turn on or turn off the headlight in accordance with the acquired lamp instruction signal. The second processor is configured to determine whether communication with the first processor is interrupted due to an abnormality based on the diagnosed communication state with the first processor and the acquired vehicle state signal.

(2) In (1), the second processor may further be configured to execute control to forcibly turn on the headlight when communication with the first processor is determined to be interrupted due to an abnormality.

(3) In (1) or (2), the second processor may further be configured to determine that the communication with the first processor is interrupted due to an abnormality while the vehicle is traveling when the second processor diagnoses that communication with the first processor is interrupted when the second processor acquires the traveling state signal.

(4) In any one of (1) to (3), the headlight control device may further include a power relay configured to allow or interrupt supply of electric power from a power supply of the vehicle to the second processor. The first processor may be configured to control the power relay. The first processor may diagnose a communication state with the second processor. The first processor may be configured to, when the vehicle is detected to have changed from the stopped state to the traveling state, determine whether communication with the second processor is interrupted due to an abnormality, based on the diagnosed communication state with the second processor. The first processor is configured to, when the communication with the second processor is determined to be interrupted due to an abnormality, execute control to switch the power relay from an ON state to an OFF state for a first predetermined time. And then the first processor may be configured to execute control to switch the power relay from the OFF state to the ON state again. The second processor is configured to, when the communication with the first processor is determined to be interrupted for a second predetermined time after the power relay is switched to the ON state again, determine that the communication with the first processor is interrupted due to an abnormality while the vehicle is stopped.

(5) In any one of (1) to (4), the first processor may further be configured to output the lamp instruction signal and the vehicle state signal to the second processor through Controller Area Network communication (hereinafter CAN communication). The first processor may be configured to stop the CAN communication when the vehicle is detected to be in the stopped state. The second processor may be configured to determine whether the CAN communication with the first processor is interrupted due to an abnormality. This determination may be based on the communication state with the first processor and the vehicle state signal.

(6) Another aspect of the present disclosure is a lamp driver that is mounted on a vehicle. The lamp driver is configured to turn on or turn off a headlight in accordance with an instruction of a first processor. The first processor is configured to output a lamp instruction signal to turn on or turn off the headlight, and a vehicle state signal corresponding to a traveling state or a stopped state of the vehicle. The lamp driver comprises a second processor. The second processor is configured to diagnose a communication state with the first processor. The second processor is configured to acquire the lamp instruction signal and the vehicle state signal that are output from the first processor. The second processor is configured to execute control to turn on or turn off the headlight in accordance with the acquired lamp instruction signal. The second processor is configured to determine whether communication with the first processor is interrupted due to an abnormality based on the diagnosed communication state with the first processor and the acquired vehicle state signal.

The present disclosure enables cost reduction and simplification of wiring.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a headlight control device according to an embodiment of the present disclosure;

FIG. 2 is a flowchart showing a procedure of a power control process executed by a controller of an instruction unit shown in FIG. 1;

FIG. 3 is a flowchart showing a procedure of a lamp control process executed by a controller of a lamp driver shown in FIG. 1;

FIG. 4 is a timing chart showing a state in which a low beam light source is forcibly turned on when CAN communication between the instruction unit and the lamp driver is interrupted due to an abnormality while a vehicle is traveling;

FIG. 5 is a timing chart showing a state in which the CAN communication between the instruction unit and the lamp driver is intentionally stopped when the vehicle changes from a traveling state to a stopped state; and

FIG. 6 is a timing chart showing a state in which the low beam light source is forcibly turned on when the vehicle changes from the stopped state to the traveling state after the CAN communication between the instruction unit and the lamp driver is interrupted due to an abnormality while the vehicle is stopped.

### DETAILED DESCRIPTION OF EMBODIMENTS

Hereinbelow, an embodiment of the present disclosure will be described in detail with reference to the drawings.

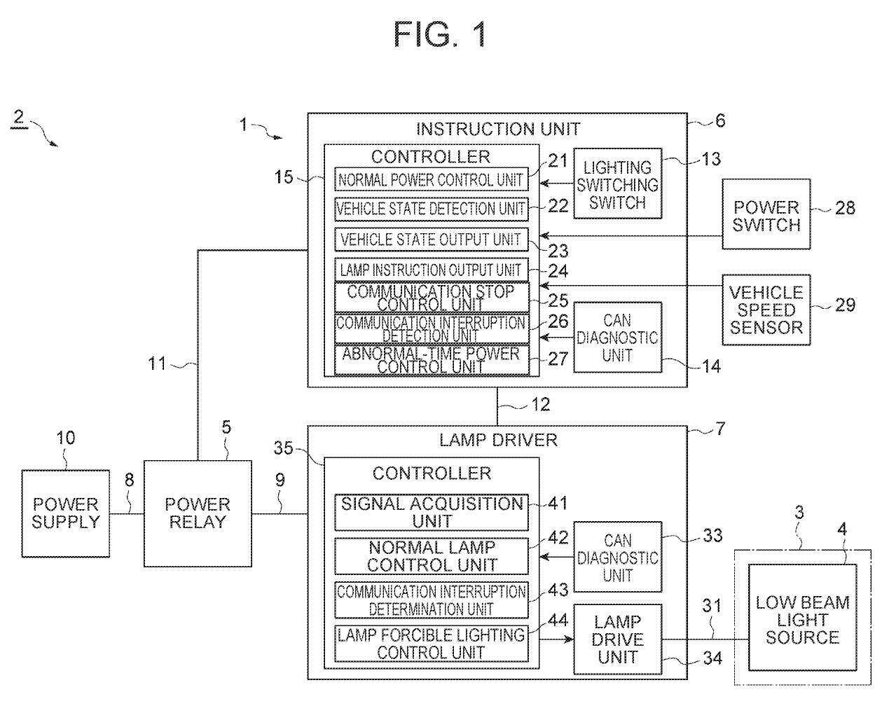

FIG. 1 is a block diagram showing a configuration of a headlight control device according to an embodiment of the present disclosure. In FIG. 1, a headlight control device 1 of the present embodiment is mounted on a vehicle 2 such as a motor vehicle. The headlight control device 1 controls low beam light sources 4 of two headlights 3 (headlamps) that are disposed on the right and left sides of a front portion of the vehicle 2. Although not shown, each of the headlights 3 also includes a high beam light source.

The headlight control device 1 includes a power relay 5, an instruction unit 6, and a lamp driver 7. The instruction unit 6 includes a first processor. The lamp driver 7 includes a second processor.

The power relay 5 is connected to a power supply 10 and the lamp driver 7 through power lines 8, 9, respectively. The power supply 10 is, for example, a lithium-ion secondary battery. The power lines 8, 9 are power cords that supply electric power from the power supply 10. In addition, the power relay 5 is connected to the instruction unit 6 through a signal line 11 that transmits control signals.

The power relay 5 is an electromagnetic switching unit that allows or interrupts the supply of electric power from the power supply 10 to the lamp driver 7. The power relay 5 is opened and closed (turned OFF and ON) in response to a power control signal from the instruction unit 6.

When an ON signal is input as the power control signal to the power relay 5, the power relay 5 is brought into a closed state (ON state). As a result, since the power lines 8, 9 become electrically connected to each other, electric power is supplied from the power supply 10 to the lamp driver 7. When an OFF signal is input as the power control signal to the power relay 5, the power relay 5 is bought into an open state (OFF state). As a result, since the power lines 8, 9 become electrically disconnected to each other, no electric power is supplied from the power supply 10 to the lamp driver 7.

The instruction unit 6 and the lamp driver 7 are connected through a controller area network (CAN) communication line 12. The CAN is a network protocol for communicating data between electronic control units (ECUs) inside the vehicle 2 at high speed and with high reliability.

The instruction unit 6 provides instructions to turn on and turn off the low beam light sources 4 of the headlights 3. The instruction unit 6 includes a lighting switching switch 13, a CAN diagnostic unit 14, and a controller 15.

The lighting switching switch 13 is a manual switch for a driver of the vehicle 2 to perform an instruction operation to switch between turning on and turning off the low beam light sources 4.

The CAN diagnostic unit 14 diagnoses the state of CAN communication between the instruction unit 6 and the lamp driver 7. The CAN diagnostic unit 14 diagnoses the wiring state of a CAN bus, the contents of data and an error occurrence status on the CAN bus, the operation of the CAN communication, and the like using, for example, a known diagnostic tool. The CAN diagnostic unit 14 constitutes a second diagnostic unit that diagnoses the communication state with the lamp driver 7.

The controller 15 includes a CPU, a RAM, a ROM, an input-output interface, and the like. The controller 15, for example, loads a program stored in the ROM into the RAM and executes the program loaded into the RAM using the CPU. The controller 15 operates when electric power from the power supply 10 is supplied to the controller 15.

The controller 15 includes a normal power control unit 21, a vehicle state detection unit 22, a vehicle state output unit 23, a lamp instruction output unit 24, a communication stop control unit 25, a communication interruption determination unit 26, and an abnormal-time power control unit 27. The normal power control unit 21, the vehicle state detection unit 22, the vehicle state output unit 23, the lamp instruction output unit 24, the communication stop control unit 25, the communication interruption determination unit 26, and the abnormal-time power control unit 27 are configured as, for example, functions of software. Note that the CAN diagnostic unit 14 may be one of the functions of the controller 15.

The normal power control unit 21 controls the power relay 5 in accordance with the operating state of a power switch 28. The power switch 28 is a manual switch for the driver of the vehicle 2 to perform an instruction operation to switch ON/OFF of the power relay 5. The normal power control unit 21 outputs a power control signal corresponding to the operating state of the power switch 28 to the power relay 5. The normal power control unit 21 constitutes a power control unit that controls the power relay 5.

When the power switch 28 is turned ON, the normal power control unit 21 outputs an ON signal as a power control signal to the power relay 5. When the power switch 28 is turned OFF, the normal power control unit 21 outputs an OFF signal as the power control signal to the power relay 5.

The vehicle state detection unit 22 detects whether the vehicle 2 is in a traveling state or a stopped state based on, for example, a detection value of a vehicle speed sensor 29. The vehicle speed sensor 29 detects the vehicle speed (traveling speed) of the vehicle 2. The vehicle state detection unit 22 determines that vehicle 2 is in the traveling state when the vehicle speed of the vehicle 2 is higher than a predetermined value. The vehicle state detection unit 22 determines that vehicle 2 is in the stopped state when the vehicle speed of the vehicle 2 is equal to or lower than the predetermined value. The predetermined value is zero or a value close to zero.

The vehicle state output unit 23 outputs, to the lamp driver 7, a vehicle state signal corresponding to the state (the traveling state or the stopped state) of the vehicle 2 detected by the vehicle state detection unit 22. When the vehicle state detection unit 22 detects that the vehicle 2 is in the traveling state, the vehicle state output unit 23 outputs a traveling state signal as the vehicle state signal to the lamp driver 7. When the vehicle state detection unit 22 detects that the vehicle 2 is in the stopped state, the vehicle state output unit 23 outputs a stopped state signal as the vehicle state signal to the lamp driver 7.

The lamp instruction output unit 24 outputs a lamp control signal corresponding to the operating state of the lighting switching switch 13 to the lamp driver 7. When the lighting switching switch 13 is operated for turning-on, the lamp instruction output unit 24 outputs a turning-on signal as the lamp control signal to the lamp driver 7. When the lighting switching switch 13 is operated for turning-off, the lamp instruction output unit 24 outputs a turning-off signal as the lamp control signal to the lamp driver 7.

The vehicle state output unit 23 and the lamp instruction output unit 24 constitute a signal output unit that outputs, to the lamp driver 7, a lamp instruction signal for turning on or turning off the low beam light sources 4 of the headlights 3 and the vehicle state signal corresponding to the traveling state or the stopped state detected by the vehicle state detection unit 22.

The communication stop control unit 25 stops the CAN communication between the instruction unit 6 and the lamp driver 7 when the vehicle state detection unit 22 detects that the vehicle 2 is in the stopped state. The communication stop control unit 25 forcibly stops the CAN communication, for example, by means of software or by resetting a specific node. The communication stop control unit 25 does not stop the CAN communication when the vehicle 2 is detected to be in the traveling state.

The communication interruption determination unit 26 determines whether the CAN communication between the instruction unit 6 and the lamp driver 7 is interrupted due to an abnormality when the vehicle 2 changes from the stopped state to the traveling state, based on the state of the vehicle 2 detected by the vehicle state detection unit 22 and the state of the CAN communication diagnosed by the CAN diagnostic unit 14.

The communication interruption determination unit 26 constitutes a second determination unit that determines whether communication with the lamp driver 7 is interrupted due to an abnormality based on the communication state with the lamp driver 7 diagnosed by the CAN diagnostic unit 14 when the vehicle state detection unit 22 detects that the vehicle 2 has changed from the stopped state to the traveling state.

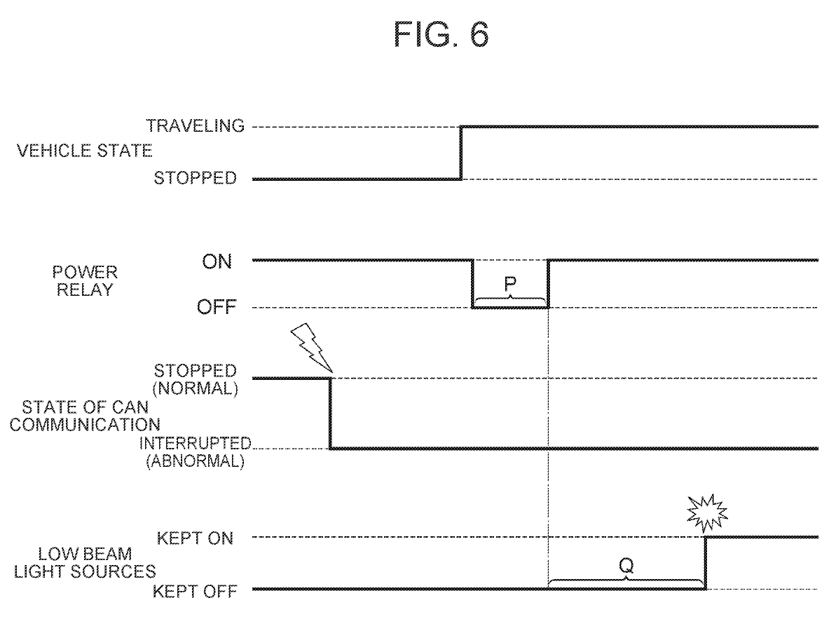

When the communication interruption determination unit 26 determines that the CAN communication is interrupted due to an abnormality when the vehicle 2 changes from the stopped state to the traveling state, the abnormal-time power control unit 27 outputs an OFF signal as the power control signal to the power relay 5 for a predetermined time P (refer to FIG. 6), and then outputs an ON signal as the power control signal to the power relay 5. The abnormal-time power control unit 27, together with the normal power control unit 21, constitutes a power control unit that controls the power relay 5.

When the communication interruption determination unit 26 determines that the communication with the lamp driver 7 is interrupted due to an abnormality, the abnormal-time power control unit 27 executes control to switch the power relay 5 from an ON state to an OFF state for a predetermined time P (first predetermined time), and then executes control to switch the power relay 5 from an OFF state to an ON state again.

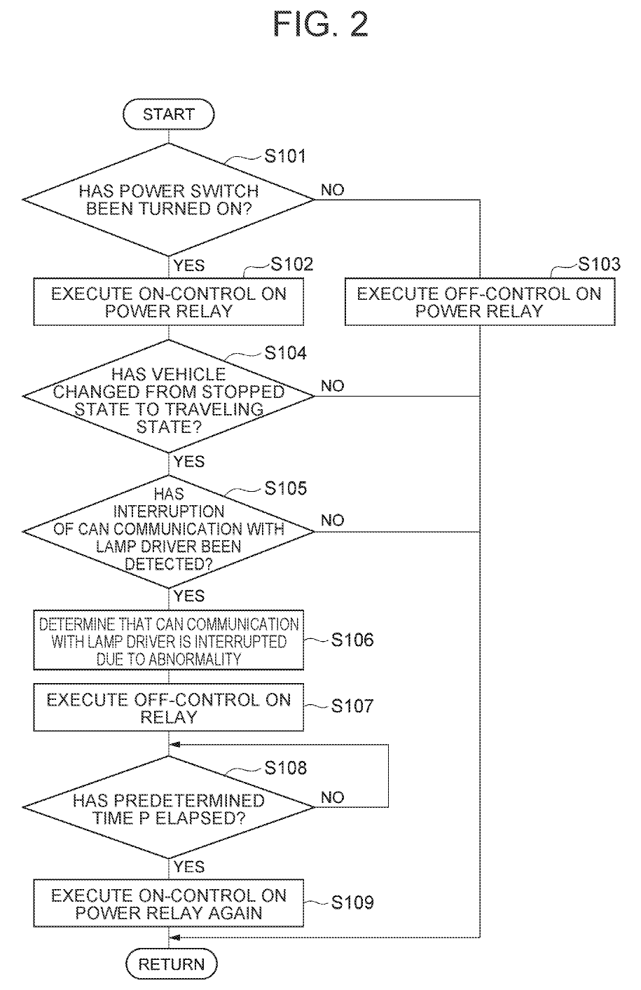

FIG. 2 is a flowchart showing a procedure of a power control process executed by the controller 15. Note that the process is executed by the normal power control unit 21, the vehicle state detection unit 22, the communication interruption determination unit 26, and the abnormal-time power control unit 27.

In FIG. 2, the controller 15 first determines whether the power switch 28 has been turned ON (procedure S101). When the controller 15 determines that the power switch 28 has been turned ON, the controller 15 executes ON-control on the power relay 5 (procedure S102). That is, the controller 15 outputs an ON signal as the power control signal to the power relay 5.

When the controller 15 determines that the power switch 28 has been turned OFF, the controller 15 executes OFF-control on the power relay 5 (procedure S103) and executes procedure S101 again. That is, the controller 15 outputs an OFF signal as the power control signal to the power relay 5.

After the controller 15 executes procedure S102, the controller 15 determines whether the vehicle 2 has changed from the stopped state to the traveling state based on the detection value of the vehicle speed sensor 29 (procedure S104). When the controller 15 determines that the condition that the vehicle 2 has changed from the stopped state to the traveling state is not satisfied, the controller executes procedure S101 again.

When the controller 15 determines that vehicle 2 has changed from the stopped state to the traveling state, the controller 15 determines whether an interruption of the CAN communication with the lamp driver 7 has been detected based on a diagnostic result of the CAN diagnostic unit 14 (procedure S105). When the controller 15 determines that the interruption of the CAN communication with the lamp driver 7 has been detected, the controller 15 determines that the CAN communication with the lamp driver 7 is interrupted due to an abnormality (procedure S106).

Then, the controller 15 executes OFF-control on the power relay 5 (procedure S107). That is, the controller 15 outputs an OFF signal as the power control signal to the power relay 5. Next, the controller 15 determines whether the predetermined time P (refer to FIG. 6) has elapsed after the start of the OFF-control on the power relay 5 (procedure S108). The predetermined time P is, for example, 5 seconds. When the controller 15 determines that the predetermined time P has elapsed, the controller 15 executes ON-control on the power relay 5 again (procedure S109) and executes procedure S101 again.

The normal power control unit 21 executes procedures S101 to S103. The vehicle state detection unit 22 executes procedure S104. The communication interruption determination unit 26 executes procedures S105 and S106. The abnormal-time power control unit 27 executes procedures S107 to S109.

Referring back to FIG. 1, the lamp driver 7 is connected to the low beam light sources 4 of the headlights 3 through an electric line 31 that supplies electric power and transmits control signals. The lamp driver 7 includes a CAN diagnostic unit 33, a lamp drive unit 34, and a controller 35.

The CAN diagnostic unit 33 diagnoses the state of the CAN communication between the instruction unit 6 and the lamp driver 7. The CAN diagnostic unit 33 diagnoses the state of the CAN communication using the same method as the method used by the CAN diagnostic unit 14. The CAN diagnostic unit 33 constitutes a first diagnostic unit that diagnoses the communication state with the instruction unit 6.

The lamp drive unit 34 drives the low beam light sources 4 to turn on or turn off in accordance with an instruction of the instruction unit 6. The lamp drive unit 34 is connected to the low beam light sources 4 through the electric line 31. The lamp drive unit 34 outputs a current and a voltage corresponding to the instruction of the instruction unit 6 to the low beam light sources 4.

The controller 35 includes a CPU, a RAM, a ROM, an input-output interface, and the like. The controller 35 loads a program stored in the ROM into the RAM and executes the program loaded into the RAM using the CPU. The controller 35 operates when electric power from the power supply 10 is supplied to the controller 35 through the power relay 5.

The controller 35 includes a signal acquisition unit 41, a normal lamp control unit 42, a communication interruption determination unit 43, and a lamp forcible lighting control unit 44. The signal acquisition unit 41, the normal lamp control unit 42, the communication interruption determination unit 43, and the lamp forcible lighting control unit 44 are configured as, for example, functions of software. Note that the CAN diagnostic unit 33 may be one of the functions of the controller 35.

The signal acquisition unit 41 acquires the lamp instruction signal and the vehicle state signal that are output from the controller 15 of the instruction unit 6.

The normal lamp control unit 42 controls the lamp drive unit 34 in accordance with the lamp instruction signal acquired by the signal acquisition unit 41. The normal lamp control unit 42 constitutes, in cooperation with the lamp drive unit 34, a normal control unit that executes control to turn on or turn off the low beam light sources 4 of the headlights 3 in accordance with the lamp instruction signal acquired by the signal acquisition unit 41.

When the turning-on signal is acquired as the lamp instruction signal, the normal lamp control unit 42 controls the lamp drive unit 34 to turn on the low beam light sources 4. When the turning-off signal is acquired as the lamp instruction signal, the normal lamp control unit 42 controls the lamp drive unit 34 to turn off the low beam light sources 4.

The communication interruption determination unit 43 determines whether the CAN communication between the instruction unit 6 and the lamp driver 7 is interrupted due to an abnormality based on the state of the CAN communication diagnosed by the CAN diagnostic unit 33 and the vehicle state signal acquired by the signal acquisition unit 41. The communication interruption determination unit 43 constitutes a first determination unit that determines whether the communication with the instruction unit 6 is interrupted due to an abnormality based on the communication state with the instruction unit 6 diagnosed by the CAN diagnostic unit 33 and the vehicle state signal acquired by the signal acquisition unit 41.

When the CAN diagnostic unit 33 diagnoses that the communication with the instruction unit 6 is interrupted when the signal acquisition unit 41 acquires the traveling state signal as the vehicle state signal, the communication interruption determination unit 43 determines that the communication with the instruction unit 6 is interrupted due to an abnormality while the vehicle 2 is traveling.

When the CAN diagnostic unit 33 diagnoses that the communication with the instruction unit 6 is interrupted for a predetermined time Q (second predetermined time) after the power relay 5 is switched from the OFF state to the ON state again, the communication interruption determination unit 43 determines that the communication with the instruction unit 6 is interrupted due to an abnormality while the vehicle 2 is stopped.

When the communication interruption determination unit 43 determines that the CAN communication with the instruction unit 6 is interrupted due to an abnormality, the lamp forcible lighting control unit 44 controls the lamp drive unit 34 to forcibly turn on the low beam light sources 4 of the headlights 3. The lamp forcible lighting control unit 44 constitutes, in cooperation with the lamp drive unit 34, a forcible lighting control unit that executes control to forcibly turn on the low beam light sources 4 of the headlights 3 when the communication interruption determination unit 43 determines that the communication with the instruction unit 6 is interrupted due to an abnormality.

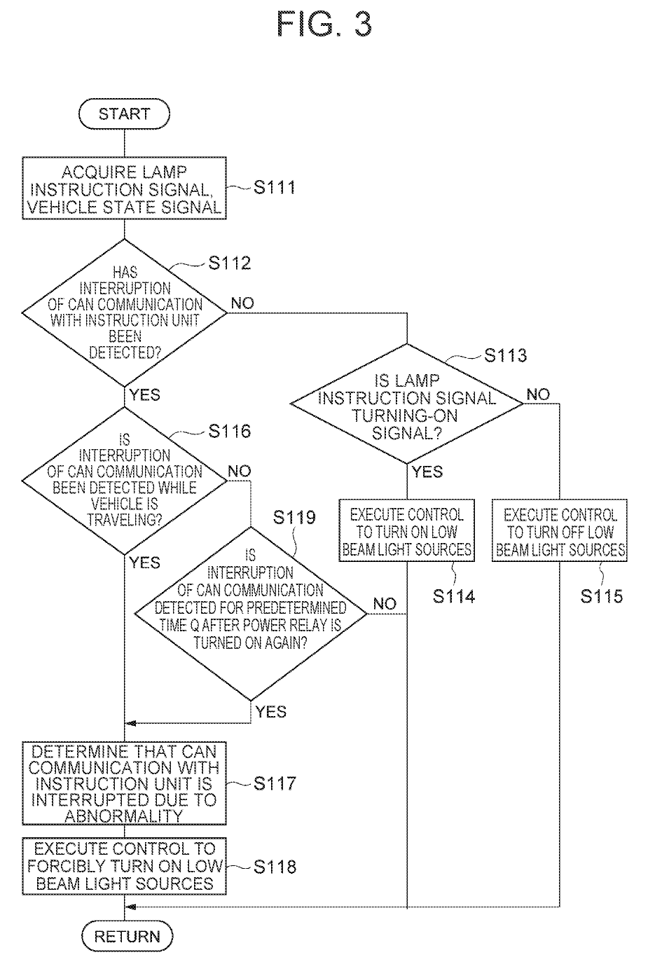

FIG. 3 is a flowchart showing a procedure of a lamp control process executed by the controller 35.

In FIG. 3, the controller 35 first acquires a lamp instruction signal and a vehicle state signal that are output from the controller 15 of the instruction unit 6 (procedure S111). The lamp instruction signal and the vehicle state signal are acquired at short intervals (e.g., 100 mS to 1 S).

Then, the controller 35 determines whether an interruption of the CAN communication with the instruction unit 6 has been detected based on the state of the CAN communication diagnosed by the CAN diagnostic unit 33 (procedure S112). When the controller 35 determines that no interruption of the CAN communication with the instruction unit 6 has been detected, the controller 35 determines whether the lamp instruction signal acquired in procedure S111 is the turning-on signal (procedure S113).

When the controller 35 determines that the lamp instruction signal is the turning-on signal, the controller 35 controls the lamp drive unit 34 to turn on the low beam light sources 4 (procedure S114), and executes procedure S111 again. That is, the controller 35 outputs a control signal to turn on the low beam light sources 4 to the lamp drive unit 34.

When the controller 35 determines that the lamp instruction signal is the turning-off signal, the controller 35 controls the lamp drive unit 34 to turn off the low beam light sources 4 (procedure S115), and executes procedure S111 again. That is, the controller 35 outputs a control signal to turn off the low beam light sources 4 to the lamp drive unit 34.

When the controller 35 determines in procedure S112 that an interruption of the CAN communication with the instruction unit 6 has been detected, the controller 35 determines whether the interruption of the CAN communication with the instruction unit 6 is detected while the vehicle 2 is traveling based on the vehicle state signal acquired in procedure S111 (procedure S116).

When the controller 35 determines that the interruption of the CAN communication with the instruction unit 6 is detected while the vehicle 2 is traveling, the controller 35 determines that the CAN communication with the instruction unit 6 is interrupted due to an abnormality while the vehicle 2 is traveling (procedure S117).

Then, the controller 35 controls the lamp drive unit 34 to forcibly turn on the low beam light sources 4 (procedure S118), and executes procedure S111 again. That is, the controller 35 outputs a control signal to forcibly turn on the low beam light sources 4 to the lamp drive unit 34.

When the controller 35 determines that the condition that the interruption of the CAN communication with the instruction unit 6 is detected while the vehicle 2 is traveling is not satisfied, the controller 35 determines whether the interruption of the CAN communication with the instruction unit 6 is continuously detected for the predetermined time Q (refer to FIG. 6) after the power relay 5 changes from the OFF state to the ON state again (procedure S119). The predetermined time Q is, for example, 10 seconds. Note that the state of the power relay 5 may be determined based on the power control signal output from the controller 15 of the instruction unit 6.

When the controller 35 determines that the interruption of the CAN communication with the instruction unit 6 is continuously detected for the predetermined time Q after the power relay 5 changes from the OFF state to the ON state again, the controller 35 determines that the communication with the instruction unit 6 is interrupted due to an abnormality while the vehicle 2 is stopped (procedure S117). Then, the controller 35 controls the lamp drive unit 34 to forcibly turn on the low beam light sources 4 (procedure S118), and executes procedure S111 again.

When the controller 35 determines that the condition that the interruption of the CAN communication with the instruction unit 6 is continuously detected for the predetermined time Q after the power relay 5 changes from the OFF state to the ON state again is not satisfied, the controller 35 does not execute procedures S117 and S118, and executes procedure S111 again.

The signal acquisition unit 41 executes procedure S111. The normal lamp control unit 42 executes procedures S113 to S115. The communication interruption determination unit 43 executes procedures S112, S116, S117, and S119. The lamp forcible lighting control unit 44 executes procedure S118.

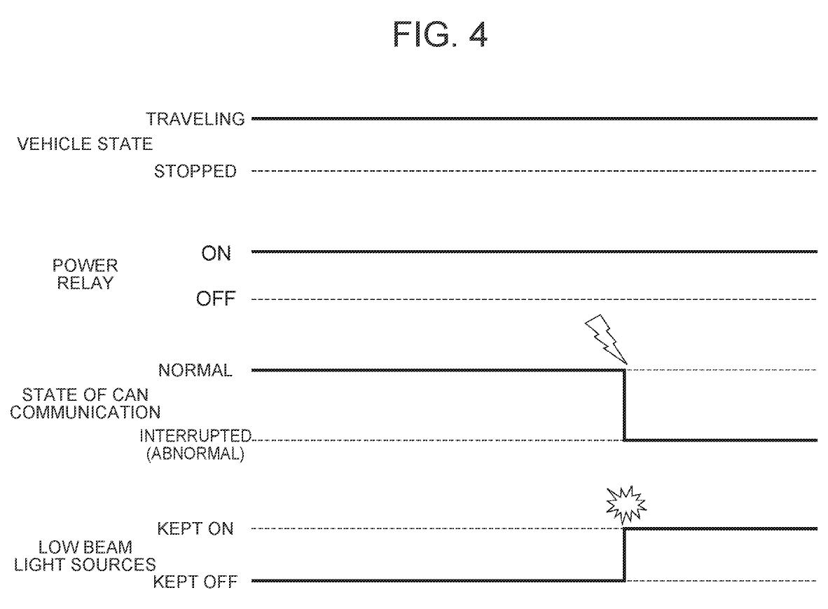

In the headlight control device 1 as described above, as shown in FIG. 4, when the vehicle 2 is traveling with the low beam light sources 4 kept off, the CAN communication between the instruction unit 6 and the lamp driver 7 is normally in a normal state. At this time, the power relay 5 is in the ON state. When the CAN communication is interrupted due to an abnormality while the vehicle 2 is traveling as such, the low beam light sources 4 are forcibly turned on (refer to "STATE OF CAN COMMUNICATION" and "LOW BEAM LIGHT SOURCES" in FIG. 4).

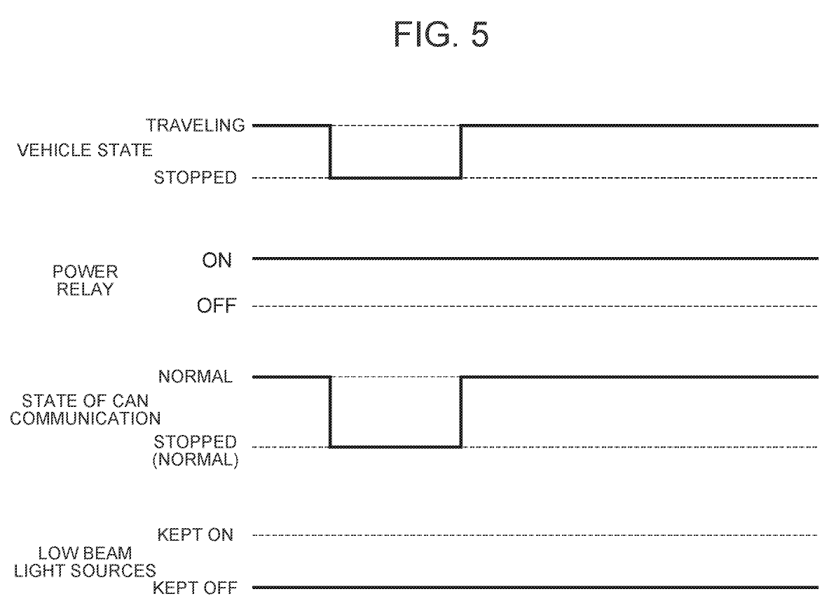

In addition, as shown in FIG. 5, when the vehicle 2 changes from the traveling state to the stopped state with the low beam light sources 4 kept off, even if the CAN communication between the instruction unit 6 and the lamp driver 7 is in a normal state, the CAN communication is intentionally stopped to reduce standby electric power (refer to "STATE OF CAN COMMUNICATION" in FIG. 5). Thereafter, when the vehicle 2 changes from the stopped state to the traveling state, the CAN communication is resumed (refer to "STATE OF CAN COMMUNICATION" in FIG. 5). At this time, since the CAN communication is in a normal state, the low beam light sources 4 are kept off (refer to "LOW BEAM LIGHT SOURCES" in FIG. 5).

As shown in FIG. 6, while the vehicle 2 is stopped with the low beam light sources 4 kept off, even though the CAN communication between the instruction unit 6 and the lamp driver 7 is in a normal state, the CAN communication is normally intentionally stopped as described above. At this time, the power relay 5 is in the ON state. While the vehicle 2 is stopped as such, the CAN communication may be interrupted due to an abnormality (refer to "STATE OF CAN COMMUNICATION" in FIG. 6).

In this case, when the vehicle 2 changes from the stopped state to the traveling state, the power relay 5 is switched from the ON state to the OFF state (refer to "VEHICLE STATE" and "POWER RELAY" in FIG. 6). Then, when the predetermined time P elapses after the power relay 5 becomes the OFF state, the power relay 5 is switched from the OFF state to the ON state again. When a state in which the CAN communication is interrupted due to an abnormality continues for the predetermined time Q after the power relay 5 becomes the ON state again, the low beam light sources 4 are forcibly turned on (refer to "STATE OF CAN COMMUNICATION" and " LOW BEAM LIGHT SOURCES" in FIG. 6).

Accordingly, while the vehicle 2 is traveling, when the CAN communication between the instruction unit 6 and the lamp driver 7 is interrupted due to an abnormality and the lamp control signal output from the instruction unit 6 thus becomes unacquired by the lamp driver 7, the low-beam light sources 4 are forcibly turned on.

In addition, while the vehicle 2 is stopped, when the CAN communication between the instruction unit 6 and the lamp driver 7 is interrupted due to an abnormality and the lamp control signal output from the instruction unit 6 thus becomes unacquired by the lamp driver 7, and the vehicle 2 then changes from the stopped state to the traveling state, the low beam light sources 4 are forcibly turned on.

As described above, in the present embodiment, in the instruction unit 6, whether the vehicle 2 is in the traveling state or the stopped state is detected, and the vehicle state signal corresponding to the traveling state or the stopped state is output to the lamp driver 7. In the lamp driver 7, the communication state with the instruction unit 6 is diagnosed, and the vehicle state signal from the instruction unit 6 is acquired. Based on the communication state with the instruction unit 6 and the vehicle state signal, a determination is made whether the communication with the instruction unit 6 is interrupted due to an abnormality. Thus, when the communication between the instruction unit 6 and the lamp driver 7 is interrupted while the vehicle 2 is stopped, a determination is made whether the interruption is the interruption of the communication due to an abnormality or the interruption of the communication caused by intentionally stopping the communication, without using a dedicated line for notifying the lamp driver 7 of the stopped state of the vehicle 2. This enables cost reduction and simplification of wiring in the headlight control device 1 including the lamp driver 7.

In addition, in the present embodiment, when the communication with the instruction unit 6 is determined to be interrupted due to an abnormality, the low beam light sources 4 of the headlights 3 are controlled to be forcibly turned on. In this manner, since the low beam light sources 4 are forcibly turned on when the communication between the instruction unit 6 and the lamp driver 7 is interrupted due to an abnormality, the vehicle 2 can be caused to travel appropriately.

In addition, in the present embodiment, when the CAN diagnostic unit 33 diagnoses that the communication with the instruction unit 6 is interrupted when the traveling state signal is acquired as the vehicle state signal, the communication with the instruction unit 6 is determined to be interrupted due to an abnormality while the vehicle 2 is traveling. Thus, the communication between the instruction unit 6 and the lamp driver 7 is easily determined to be interrupted due to an abnormality while the vehicle 2 is traveling.

In addition, in the present embodiment, when, in the instruction unit 6, the communication state with the lamp driver 7 is diagnosed and the vehicle 2 is detected to have changed from the stopped state to the traveling state, a determination is made whether the communication with the lamp driver 7 is interrupted due to an abnormality based on the communication state with the lamp driver 7. When the communication with the lamp driver 7 is determined to be interrupted due to an abnormality, the power relay 5 is controlled to be switched from the ON state to the OFF state for the predetermined time P, and the power relay 5 is then controlled to be switched from the OFF state to the ON state again. In the lamp driver 7, when the CAN diagnostic unit 33 diagnoses that the communication with the instruction unit 6 is interrupted for the predetermined time Q after the power relay 5 is switched to the ON state again, the communication with the instruction unit 6 is determined to be interrupted due to an abnormality while the vehicle 2 is stopped. In this manner, when the vehicle 2 has changed from the stopped state to the traveling state, the communication between the instruction unit 6 and the lamp driver 7 is reliably determined to be interrupted due to an abnormality while the vehicle 2 is stopped.

In addition, in the present embodiment, when the CAN communication between the instruction unit 6 and the lamp driver 7 is interrupted while the vehicle 2 is stopped, a determination is made whether the interruption is the interruption of the CAN communication due to an abnormality or the interruption of the CAN communication caused by intentionally stopping the CAN communication, without using a dedicated line for notifying the lamp driver 7 of the stopped state of the vehicle 2 separately from the CAN communication line 12 for performing CAN communication.

In addition, in the present embodiment, since the instruction unit 6 has the function of controlling the power relay 5, it is not necessary to add a separate configuration to control the power relay 5, thereby enabling further cost reduction in the headlight control device 1.

The present disclosure is not limited to the embodiment described above. For example, although, in the embodiment, the lamp control signal and the vehicle state signal that are generated by the instruction unit 6 are transmitted to the lamp driver 7 through the CAN communication, the present disclosure is not particularly limited to this mode. The lamp control signal and the vehicle state signal may be transmitted from the instruction unit 6 to the lamp driver 7 through communication using a network protocol other than the CAN communication.

In addition, although, in the embodiment, whether the vehicle 2 is in the traveling state or the stopped state is detected based on the detection value of the vehicle speed sensor 29, the present disclosure is not particularly limited to this mode. Whether the vehicle 2 is in the traveling state or the stopped state may be determined based on, for example, an operation signal of an ignition (IG) switch.

In addition, although, in the embodiment, the low beam light sources 4 of the headlights 3 are controlled, the present disclosure is also applicable to a device that controls the high beam light sources (not shown) of the headlights

What is claimed is:

1. A headlight control device configured to control a headlight of a vehicle, the headlight control device comprising:
a first processor configured to provide an instruction to turn on and turn off the headlight; and
a second processor configured to turn on or turn off the headlight in accordance with the instruction of the first processor, wherein:
the first processor is configured to
detect whether the vehicle is in a traveling state or a stopped state as a vehicle state, and
output, to the second processor, a lamp instruction signal to turn on or turn off the headlight, and a traveling state signal or a stopped state signal as a vehicle state signal corresponding to the vehicle state; and
the second processor is configured to
diagnose a communication state with the first processor,
acquire the lamp instruction signal and the vehicle state signal that are output from the first processor,
execute control to turn on or turn off the headlight in accordance with the acquired lamp instruction signal, and
determine whether communication with the first processor is interrupted due to an abnormality based on the diagnosed communication state with the first processor and the acquired vehicle state signal.

2. The headlight control device according to claim 1, wherein the second processor is configured to execute control to forcibly turn on the headlight when communication with the first processor is determined to be interrupted due to an abnormality.

3. The headlight control device according to claim 1, wherein the second processor is configured to determine that the communication with the first processor is interrupted due to an abnormality while the vehicle is traveling when the second processor diagnoses that communication with the first processor is interrupted when the second processor acquires the traveling state signal.

4. The headlight control device according to claim 1, further comprising a power relay configured to allow or interrupt supply of electric power from a power supply of the vehicle to the second processor, wherein:
the first processor is configured to
control the power relay, and diagnose a communication state with the second processor, and
determine whether communication with the second processor is interrupted due to an abnormality based on the diagnosed communication state with the second processor when the vehicle is detected to have changed from the stopped state to the traveling state;
the first processor is configured to, when the communication with the second processor is determined to be interrupted due to an abnormality, execute control to switch the power relay from an ON state to an OFF state for a first predetermined time, and then execute control to switch the power relay from the OFF state to the ON state again; and
the second processor is configured to, when the communication with the first processor is determined to be interrupted for a second predetermined time after the power relay is switched to the ON state again, determine that the communication with the first processor is interrupted due to an abnormality while the vehicle is stopped.

5. The headlight control device according to claim 1, wherein the first processor is configured to output the lamp instruction signal and the vehicle state signal to the second processor through Controller Area Network communication, the first processor is configured to stop the CAN communication when the vehicle is detected to be in the stopped state, and the second processor is configured to determine whether the CAN communication with the first processor is interrupted due to an abnormality based on the communication state with the first processor and the vehicle state signal.

6. A lamp driver mounted on a vehicle, the lamp driver being configured to turn on or turn off a headlight in accordance with an instruction of a first processor, the first processor being configured to output a lamp instruction signal to turn on or turn off the headlight and a vehicle state signal corresponding to a traveling state or a stopped state of the vehicle, the lamp driver comprising a second processor, wherein
the second processor is configured to:
diagnose a communication state with the first processor;
acquire the lamp instruction signal and the vehicle state signal that are output from the first processor;
execute control to turn on or turn off the headlight in accordance with the acquired lamp instruction signal; and
determine whether communication with the first processor is interrupted due to an abnormality based on the diagnosed communication state with the first processor and the acquired vehicle state signal.
